(19) United States
(12) Patent Application Publication
(10) Pub. No.: US 2024/0265910 A1
(43) Pub. Date: Aug. 8, 2024

(54) METHOD AND APPARATUS FOR AUDIO CONTENT CREATION VIA A COMBINATION OF A TEXT-TO-SPEECH MODEL AND HUMAN NARRATION

(71) Applicant: Recorded Books, Inc., Prince Frederick, MD (US)

(72) Inventors: Dion Michael PYLAND, Elberta, AL (US); John Michael SHEA, Vienna, VA (US)

(21) Appl. No.: 18/140,051

(22) Filed: Apr. 27, 2023

Related U.S. Application Data
(60) Provisional application No. 63/444,184, filed on Feb. 8, 2023.

(51) Int. Cl. G10L 13/047

(52) U.S. Cl. CPC G10L 13/047

(57) ABSTRACT

In an embodiment, a set of text is received. Initial audio content substantially corresponding to a voice of a user, associated with the set of text and generated by a text-to-speech (TTS) model that was trained using training data that includes audio of the user, is received. A subset of text from the set of text that is to be recorded by the user is identified, based on analysis of the initial audio content. A signal indicating that the subset of text are to be recorded by the user is sent to cause the second compute device to generate a user recording. A representation of the user recording is received. Portions of the initial audio content associated with the subset of text are caused to be updated using the user recording to generate updated audio content.

### CROSS-REFERENCE TO RELATED PATENT APPLICATIONS

This application claims priority to and benefit of U.S. Provisional Patent Application No. 63/444,184, filed on Feb. 8, 2023, and entitled “Method and Apparatus for Audio Content Creation Via a Combination of a Text-To-Speech Model and Human Narration,” the entire content of which is incorporated herein by reference in its entity.

### FIELD

One or more embodiments are related to a method and apparatus for audio content creation via a combination of a text-to-speech model and human narration.

### BACKGROUND

Audio content that originates in written form is typically generated using one of human narration or artificial intelligence (AI) voice/text-to-speech (TTS) technologies. Using only human narration, however, can be expensive and time consuming. Using only TTS technology, however, can lower audio quality.

### SUMMARY

In an embodiment, a method includes receiving, via a processor of a first compute device, a set of text. The method further includes receiving, via the processor and without requiring human intervention, initial audio content substantially corresponding to a voice of a user, associated with the set of text and generated by a text-to-speech (TTS) model that was trained using training data that includes audio of the user. The method further includes identifying, via the processor and based on analysis of the initial audio content, a subset of text from the set of text that is to be recorded by the user. The method also includes sending, via the processor and to a second compute device that is different from the first compute device, a signal indicating that the subset of text are to be recorded by the user to cause the second compute device to generate a user recording. The method further includes receiving, via the processor and from the second compute device, a representation of the user recording. The method also includes causing, via the processor, portions of the initial audio content associated with the subset of text to be updated using the user recording to generate updated audio content. In an embodiment, an apparatus, includes a processor and a memory coupled to the processor. The memory stores instructions that when executed cause the processor to receive a set of text. The instructions also cause the processor to receive, without requiring human intervention, initial audio content associated with the set of text and generated by a text-to-speech (TTS) model that was trained using training data that includes audio of a user and that generates output substantially corresponding to a voice of the user. The instructions further cause the processor to send, to a compute device, a signal that causes, based on analysis of the initial audio content, a subset of text from the set of text to be recorded by the user to generate a representation of a user recording. The instructions further cause the processor to receive the representation of the user recording, and cause portions of the initial audio content associated with the subset of text to be updated using the user recording to generate updated audio content.

In an embodiment, a processor-readable medium stores instructions that, when executed by a processor, cause the processor to receive a set of text. The instructions further cause the processor to receive, without requiring human intervention, initial audio content associated with the set of text and generated by a text-to-speech (TTS) model that was trained using training data that includes audio of a user and that generates output substantially corresponding to a voice of the user. The instructions also cause the processor to send, to a compute device, a signal that causes, based on analysis of the initial audio content, a subset of text from the set of text to be recorded by the user to generate a representation of a user recording. The instructions further cause the processor to receive the representation of the user recording, and cause portions of the initial audio content associated with the subset of text to be updated using the user recording to generate updated audio content.

### BRIEF DESCRIPTION OF THE DRAWINGS

FIG. 1 shows a system block diagram for audio content generation from written text via a hybrid approach that combines TTS and human narration, according to an embodiment.

FIG. 2 shows a flowchart of a method to cause audio content to be generated based on a set of text and a user recording of a subset of text, according to an embodiment.

FIG. 3 shows a flowchart of a method to cause updated audio content to be generated based on a set of text and a user recording of a subset of text, according to another embodiment.

FIG. 4 shows a flowchart of a method to cause updated audio content to be generated based on a set of text and a user recording of a subset of text, according to an embodiment.

### DETAILED DESCRIPTION

Some implementations are related to generating audio content (e.g., an audiobook) using a text-to-speech (TTS) AI voice model and human narration. In some implementations, a TTS AI voice model can receive a set of text to generate audio content. That audio content can be analyzed to identify portions that should be recorded via human narration. A representation of a subset of text from the set of text that is associated with the portions of the audio content that is to be recorded via human narration is made known to a voice actor. In some instances, a software runs on a compute device that guides the voice actor through a recording process so that the voice actor narrates the subset of text. For example, the compute device can display the subset of text for the voice actor to narrate via the software. Additionally, the compute device can include a microphone to capture the voice actor's narration (e.g., while the subset of text is displayed). Additionally, the compute device can update the portions of the audio content associated with the subset of text with the voice actor's narrations of the subset of text.

Some implementations use a hybrid approach that combines human narration and TTS. This hybrid approach can enable audio content generated from written text to be produced faster, at a lower cost, with less of a computing burden, and/or with a higher quality audio output than previously possible. For example, implementing human recording in audio content generation can enable a compute device to generate audio content with quality better than if only artificial intelligence techniques were used. As another example, implementing artificial intelligence techniques, like a TTS AI voice model, can enable a compute device to generate audio content faster and/or cheaper than if only human recording techniques were used.

In some implementations, the TTS AI voice model is trained using recordings of a human's voice. For example, in some implementations, audio from each voice actor from a group of voice actors can be used to train one or more TTS AI voice models to produce synthetic audio for books. In this example, each voice actor can read from an extended script (e.g., a four-hour script) that covers specific words and sounds. In other implementations, audio from a voice actor (or multiple voice actors) reading books in different genres (e.g., business, science fiction, etc.) can be used to train one or more TTS AI voice models to produce synthetic audio for books in that respective genre(s). In certain implementations, a combination of training audio can be used both from a voice actor (or voice actors) reading from a script as well as reading books in specific genres. In some implementations, any voice corrections to the synthetic audio is made by the same voice actor whose voice was used to train the related one or more TTS AI voice models. In some instances, a different TTS AI voice model (e.g., trained by a genre-specific voice actor) could be used to produce synthetic audio for books for different genres (e.g., a first TTS AI voice model is used to produce synthetic audio for business books, a second TTS AI voice model is used to produced synthetic audio for science books, etc.) after being trained.

In some instances, the TTS AI voice model is a neural network. The neural network can be trained using input learning data, which can include a recording of a voice actor narrating the text (e.g., an audiobook). The recording can be a recording that has been identified as acceptable (e.g., by a voice actor and/or a quality-checking software model).

After completing training, the TTS AI voice model can be used to generate audio content from a set of text. The audio content generated by the TTS AI voice model (having the trained neural network) can be in substantially the same voice as the voice actor whose recordings were used to train that TTS AI voice model. The audio content generated by the TTS AI voice model can be in substantially the same voice as the voice actor in the sense that any differences can be, for example, attributed to potential shortcomings in a TTS AI voice model to exactly replicate the voice used to train the TTS AI voice model. Such differences can include, for example, the audio content generated by the TTS AI voice model lacking natural voice imperfections (e.g., stutters, hesitations and breach sounds), emotional subtleties and cues (e.g., that convey feelings, intentions and/or attitudes), expressiveness (e.g., variations in pitch, tone and emotions), etc. In sum, the audio content generated by the TTS AI voice model can be substantially the same as the voice of the voice actor whose recordings were used to train that TTS AI voice model even if not identical.

As part of the process of the TTS AI voice model producing audio content from a set of text, optional preprocessing can be performed using, for example, another AI model referred to herein as a “preprocessing AI model”. The preprocessing AI model can be previously trained using data text files that include edits/revisions applied to prior audio content (such as audio books) to improve the quality of audio content (such as inserting a long pause or providing more emphasis to improve the listenability of the audio content from the perspective of the typical user). After the preprocessing AI model has been trained, it can ingest text (such as a book) and pre-apply edits to the text to improve the resulting voice output quality (e.g., by the TTS AI voice model) and save a human editor the time and effort of inputting those edits manually. In other words, the quality of the audio content generated by the TTS AI voice model using the text previously edited/revised by the preprocessing AI model is higher than the quality of audio content that could have been generated by the TTS AI voice model using text that was not previously edited/revised by the preprocessing AI model. In this context, “quality” of the audio content can relate to, for example, the user listenability as indicated by smoothness of the audio content (i.e., without a typical pauses), situationally appropriate emphasis, pronunciation, etc.

In addition and/or as an alternative to the preprocessing AI model, an initial editing pass can be made by a human to the audio content to identify areas (e.g., words, phrases, sentences, etc.) with speech quality, clarity, emotion, emphasis, etc. being less than acceptable. In such implementations, a human editor can use a software editing tool to identify areas in the text and/or audio designated for improvement. The quality of the speech output by the TTS AI voice model may be adjusted, for example, using Speech Synthesis Markup Language (SSML) or other types of tags, shortcuts, or mechanisms applied to text to control the quality of the TTS AI voice model output.

For example, a user (e.g., editor) may use an interface in an editing tool to listen to different sections of the audio content to identify areas that can be improved. Those identified areas can be then improved using the manipulation techniques noted above (e.g., SSML).

In some implementations, parts of the audio content that can be improved and/or do not sound ideal can be highlighted for a voice actor to record. The parts of the audio content identified for voice actor recording can be identified by a human, an AI model (referred to herein as a Recording Identification AI model), or a combination thereof. In some implementations, the voice actor can be the same voice actor whose voice was used to train the TTS AI voice model and whose voice is substantially the same as the audio output from the TTS AI voice model.

Those parts of the audio content that are to be recorded can be, for example, highlighted for the voice actor to record in one or more ways (e.g., via a human and/or the Recording Identification AI model). For example, text that is identified to be recorded can be highlighted on a screen (e.g., in the editing tool) through a color highlight of the text, a symbol marking of the beginning and end of the text, and/or the like. In some instances, text or voice notes can also be placed, such as a note indicating why a particular sound was identified for recording and/or how the recording should sound (e.g., different intonation, different pronunciation, different emphasis, different mood, etc.).

In some implementations, the voice actor (or someone associated with the voice actor, such as a supervisor, colleague, friend, relative, etc.) can be notified via an alert (e.g., an email, text, phone call or other message) on a compute device (e.g., the voice actor's phone or the voice actor's computer) that sections of audio content have been identified for recording. For example, the notification may be automatically or manually triggered in response to determining that a recording can be improved (e.g., by an editing tool software, by a human editor, and/or the like).

The parts of the audio content to be recorded can then be recorded by the voice actor. For example, a compute device of the voice actor can generate a notification indicating that recording is to be performed. In some implementations, the notification can be initiated at a different compute device (such as the TTS compute device or the editor compute device) and then the voice actor compute device can render the notification and display it to the voice actor. The notification may be associated with (e.g., link to) an interface that the voice actor can use to record and/or modify their recording. For example, the interface can be an audio editing tool that shows specific sections and text identified for recording. In some instances, other text that occurs before and/or after the specific sections identified for recording can also be shown (e.g., but not highlighted) and/or be played aloud. This can provide the voice actor with additional context that may be useful to know when recording, such as the general mood of the text or how certain words sound. The voice actor can also have the option to play aloud the portion of the initial audio content that is to be replaced by the voice actor's recording.

The recording can then be used to replace associated portions of the audio content. In some implementations, the sub-par portions of the audio content are removed and replaced with their associated recordings, via a software model and with or without human interaction, to generate updated audio content. In some implementations, someone (e.g., the voice actor, an editor, etc.) can integrate the recordings into the audio content previously developed using a TTS tool (e.g., using an audio editing tool like Audacity®) to generate updated audio content. In some implementations, after the updated audio content has been generated, additional editing can be performed (e.g., by a software model, by the voice actor, by a different user, and/or the like), such as smoothing, reducing noise, volume adjustment, etc.

An optional, additional AI model (referred to herein as a “Recording Identification AI model”) can analyze the audio content (i.e., TTS audio content) output by the TTS model (e.g., the TTS AI voice model) and/or the preprocessing AI model and identify automatically what audio content can be improved. The Recording Identification AI model can use a variety of sources for training, including but not limited to audio from high quality audiobooks that were previously recorded by human narrators and/or final audio from audiobooks that were produced using the hybrid TTS and human narrated approach described herein. Once trained, the Recording Identification AI model can receive audio content from the TTS AI voice model and/or the preprocessing AI model and can output an indication of specific portion(s) of specific audio content that should be further improved, for example, by notifying a voice actor compute device to re-record the indicated portion of audio content.

Note that one or more of the above-discussed examples (and/or one or more embodiments discussed herein) differ from an audio processing technique known as “inpainting” that uses a TTS model. Such “inpainting” typically relates to a process where a human produces a user recording, portions for which it may be desirable to improve or correct; such portions can be identified and replaced by converting the user recording into text, correcting the text where desired, generating audio content of the corrected text using a TTS model, and the replacing the relevant portion of the user recording with the audio content generated by the TTS model. Such “inpainting”, however, differs significantly from one or more of the techniques described herein that use a TTS model. For example, unlike “inpainting” where a human typically narrates to produce an initial audio content, the one or more techniques described herein can use a TTS model(s) to convert text into an initial audio content. Similarly, unlike “inpainting” where the user recording is typically converted into text, corrected as text and then converted to audio by a TTS model to replace the relevant portions of the initial audio content, the one or more techniques described herein identify portions of the initial audio (produced by the TTS model(s)) and its associated text for improvement/correction and then obtain a user recording based on that text from a human to replace the portions. One or more of the techniques described herein also involve notifying the human (e.g., voice actor) of the new portions to record and enabling the human to view in text form what portions to record as well as to listen to how the audio before and after those portions sounds in text-to-speech so the human can take that into account when recording so that the recording of the portions being improved/corrected will seamlessly meld with the surrounding text-to-speech audio. Moreover, here, the human producing the user recording to replace portions of the initial audio content can also be the human that produces audio content used to train the TTS model(s). Further details of one or more embodiments of the present disclosure are discussed below.

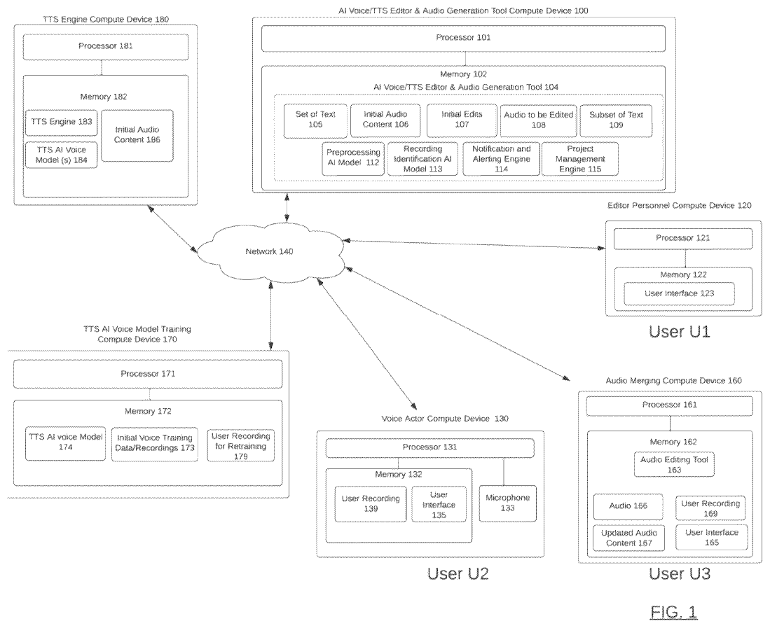

FIG. 1 shows a system block diagram for audio content generation from written text via a hybrid approach that combines TTS and human narration, according to an embodiment. FIG. 1 includes a TTS AI voice model training compute device 170, an AI voice/TTS editor & audio generation tool compute device 100, a TTS engine compute device 180, an editor personnel compute device 120, voice actor compute device 130, and an audio merging compute device 160, each operatively coupled to one another via network 140.

The network 140 can be any suitable communications network for transferring data, operating over public and/or private communications networks. For example, the network 140 can include a private network, a Virtual Private Network (VPN), a Multiprotocol Label Switching (MPLS) circuit, the Internet, an intranet, a local area network (LAN), a wide area network (WAN), a metropolitan area network (MAN), a worldwide interoperability for microwave access network (WiMAX®), an optical fiber (or fiber optic)-based network, a Bluetooth® network, a virtual network, and/or any combination thereof. In some instances, the network 140 can be a wireless network such as, for example, a Wi-Fi or wireless local area network (“WLAN”), a wireless wide area network (“WWAN”), and/or a cellular network. In other instances, the network 140 can be a wired network such as, for example, an Ethernet network, a digital subscription line (“DSL”) network, a broadband network, and/or a fiber-optic network. In some instances, the network 140 can use Application Programming Interfaces (APIs) and/or data interchange formats (e.g., Representational State Transfer (REST), JavaScript Object Notation (JSON), Extensible Markup Language (XML), Simple Object Access Protocol (SOAP), and/or Java Message Service (JMS)). The communications sent via the network 140 can be encrypted or unencrypted. In some instances, the network 140 can include multiple networks or subnetworks operatively coupled to one another by, for example, network bridges, routers, switches, gateways and/or the like.

The TTS AI model training compute device 170 includes a processor 171 operatively coupled to a memory 172 (e.g., via a system bus). The TTS AI model training compute device 170 can be used to train an initial TTS AI voice model and to retrain that model over time. As discussed further below, memory 172 can store TTS AI voice model(s) 174, initial voice training data/recordings 173 and user recording for retraining 179. The TTS AI voice model training compute device 170 can be any type of compute device, such as a server, desktop, laptop, tablet, phone, smart device, etc.

The TTS engine compute device 180 includes a processor 181 operatively coupled to a memory 182 (e.g., via a system bus). The TTS engine compute device 180 can be used to run, during operation, the TTS AI voice model(s) 184, which was trained on the TTS AI model training compute device 170 once it is uploaded to TTS engine compute device 180. As discussed further below, memory 182 can store TTS engine 183, TTS AI voice model(s) 184, and initial audio content 186. The TTS engine compute device 180 can be any type of compute device, such as a server, desktop, laptop, tablet, phone, smart device, and/or the like.

The AI voice/TTS editor & audio generation tool compute device 100 can be used to cause initial audio content to be generated using a trained TTS model (e.g., TSS AI voice model(s) 184 at TTS engine compute device 180), edit the initial audio content 106 (either via audio or text edits) resulting in initial edits 107, which then generate audio to be edited 108. AI voice/TTS editor & audio generation tool compute device 100 can then be used to identify TTS-generated audio to be recorded by a voice actor (e.g., a voice actor such as user U2 at voice actor compute device 130), notify the voice actor of the specific text needing recording and/or the like. In some instances, many of the functions performed on AI voice/TTS editor & audio generation tool compute device 100 are contained in, or part of, AI voice/TTS editor & audio generation tool 104. As discussed further below, memory 102 can store AI Voice/TTS editor & audio generation tool 104, set of text 105, initial audio content 106, initial edits 107, audio to be edited 108, subset of text 109, preprocessing AI model 112, recording-identification AI model 113, notification and alerting engine 114 and project management engine 115. Note that preprocessing AI model 112, recording-identification AI model 113 are optional and may not be included in some implementations. The AI voice/text-to-speech (TTS) editor & audio generation tool compute device 100 can be any type of compute device, such as a server, desktop, laptop, tablet, phone, smart device, and/or the like.

The editor personnel compute device 120 includes a processor 121 operatively coupled to a memory 122 (e.g., via a system bus). The edit personnel compute device 120 can be used by an editor to access and perform tasks using the AI voice/text-to-speech (TTS) editor & audio generation tool compute device 100 as well potentially as other compute devices described here depending on the embodiment. In this manner, the editor personnel compute device 120, via accessing through user interface 123 the AI voice/text-to-speech (TTS) editor & audio generation tool compute device 100 and associated AI voice/text-to-speech (TTS) editor & audio generation tool 104, can be used to identify portions of initial audio content that are to be updated, edit the initial audio content, edit updated audio content, and/or the like. The user interface 123 can be, for example, a web browser. The editor personnel compute device 120 is associated with a user U1. In some instances, user U1 is an editor. The editor personnel compute device 120 can be any type of compute device, such as a server, desktop, laptop, tablet, phone, smart device, and/or the like.

The audio merging compute device 160 includes a processor 161 operatively coupled to a memory 162 (e.g., via a system bus). The audio merging compute device 160 can be used to host an audio editing tool(s) (e.g., a custom editing tool with functions discussed here, and/or an third-party editing tool as such one made by Audacity®) as indicated by audio editing tool 163. The audio editing tool 163 can be software that can be used to facilitate audio editing (e.g., deleting audio, adding audio, recording audio, and/or the like). As discussed further below, memory 162 can include (e.g., store) the audio editing tool 163, user interface 165, audio 166, updated audio content 167, and user recording 169. The audio merging compute device 160 can be any type of compute device, such as a server, desktop, laptop, tablet, phone, smart device, and/or the like.

The voice actor compute device 130 includes a processor 131, memory 132, microphone 133, and user interface 135, each operatively coupled to one another (e.g., via a system bus). The voice compute device 130 can be used to receive and act on alerts from the AI voice/TTS editor & audio generation tool compute device 100 and associated AI voice/text-to-speech (TTS) editor & audio generation tool 104; access, via user interface 135, the AI voice/TTS editor & audio generation tool compute device 100 and associated AI voice/text-to-speech (TTS) editor & audio generation tool 104 to determine what text areas require (or would improve by) human recording and facilitate the recording of portions of initial audio content that are to be updated; and/or the like. The user interface 135 can be, for example, a web browser through which a user can perform tasks of the voice actor compute device 130. Alternatively, the user interface 135 can be associated with a voice recording software (or application) such as audio recording software (e.g., audio recording software/application native on voice actor compute device 130 when implemented for example as a mobile phone or Windows®-based personal computer). The voice actor compute device 130 is associated with a user U2. User U2 can be a voice actor in some instances and the same voice actor who recorded the initial voice training data/recordings 173 that were used to train TTS AI voice model 174. Memory 132 can store user interface 135 and user recording 139. The voice compute device 130 can be any type of compute device, such as a server, desktop, laptop, tablet, phone, smart device, and/or the like.

In some instances, user U2 uses voice actor compute device 130 to generate user recording 139. A representation of user recording 139 can be sent to audio merging compute device 160 so that audio editing tool 163 can be used to generate updated audio content 167, which combines together the audio 166 (which corresponds to the initial audio content 106) as well as the user recording 169 (which corresponds to the user recording 139). The updated audio content 167 is the output of this process and represents an audio file of hybrid audio content that seamlessly merges together TTS audio content and human narrated recordings (retakes). In some instances, the TTS audio content and the human narrated recordings (retakes) are both based on the same actor's voice: the TTS audio content sounds substantially the same as the actor's voice, and the human narrated recording (retakes) are recordings of the actor's voice.

In some instances, TTS AI voice model training compute device 170 can use those human narrator recordings to retrain a TTS model (e.g., TTS AI voice model 174). In some instances, user recording 139 are transmitted to TTS AI voice model training device 170 via network 140 and stored in memory 172 as user recording for retraining 179. The TTS AI voice model training compute device 170 can provide to the TTS AI voice model 174 the initial voice training data/recordings 173 and/or the user recording for retraining 179 to further train TTS AI voice model 174. This results in TTS AI voice model 174 to be further refined based on prior usage and then TTS AI voice model 174 can be uploaded and used for future audio generation as a new version of TTS AI voice model 184 run on TTS engine compute device 180.

The processors (e.g., processors 101, 121, 131, 161, 171 and/or 181) can be, for example, a hardware-based integrated circuit (IC) or any other suitable processing device configured to run and/or execute a set of instructions or code. For example, the processors can be a general-purpose processors, a central processing unit (CPU), an accelerated processing unit (APU), an application specific integrated circuit (ASIC), a field programmable gate array (FPGA), a programmable logic array (PLA), a complex programmable logic device (CPLD), a programmable logic controller (PLC) and/or the like. In some implementations, the processors can be configured to run any of the methods and/or portions of methods discussed herein. Any of the processors discussed herein can be combined, such as a single processor that performs the functionalities of processors 101, 121, 131, 161, 171 and/or 181.

The memories (e.g., memories 102, 122, 132, 162, 172 and/or 182) can be, for example, a random-access memory (RAM), a memory buffer, a hard drive, a read-only memory (ROM), an erasable programmable read-only memory (EPROM), and/or the like. The memories can be configured to store any data used by the processors to perform the techniques (methods, processes, etc.) discussed herein. In some instances, the memories can store, for example, one or more software programs and/or code that can include instructions to cause the processors to perform one or more processes, functions, and/or the like. In some implementations, the memories can include extendible storage units that can be added and used incrementally. In some implementations, the memories can be a portable memory (for example, a flash drive, a portable hard disk, and/or the like) that can be operatively coupled to the processors. In some instances, the memories can be remotely operatively coupled with a compute device (not shown in FIG. 1). Any of the memories discussed herein can be combined, such as a single memory that performs the functionalities of memories 102, 122, 132, 162, 172 and/or 182. In addition, although various software programs and/or code that include instructions to cause the processors to perform one or more processes, functions, and/or the like are discussed herein as stored and executed at a particular device, such various software and/or code can be any of the other various memories 102, 122, 132, 152, 162, 172 and/or 182.

The memory 172 of the TTS AI voice model training compute device 170 can include (e.g., store) initial voice training data/recordings 173 that can be used, for example, to train TTS AI voice model 174. The initial voice training data/recordings 173 can include audio content. The audio content can be a voice reading of text. In some instances, the audio content is in the voice of user U2. The audio content can be an actual recording by a human, synthetic (e.g., computer generated) audio in the voice of a human, or a combination thereof. Memory 171 can also include (e.g., store) user recording for retraining 179. The user recording for retraining 179 can be audio content associated with the initial voice training data/recordings 173 and can include rerecording by a voice actor (e.g., user U2) to capture the improved version of the initial audio content.

The memory 172 of the TTS AI voice model training compute device 170 can also include (e.g., store) a text-to-speech (TTS) AI voice model 174. The TTS AI voice model 174 can be trained using the initial voice training data/recordings 173 and user recording for retraining 179. In some instances, the text associated with initial voice training data/recordings 173 and user recording for retraining 179 can be also be used as training data for TTS AI voice model 184. The TTS AI voice model 174 can by any type of machine learning model configured to convert text to speech, such as a neural network. Once TTS AI voice 174 is trained, it can be sent from TTS AI voice model training compute device 170 to TTS engine compute device 180 and stored at TTS engine compute device 180 as TTS AI voice model 184 for subsequent integration into TTS engine 183 as discussed further below.

The memory 182 of TTS engine compute device 180 can include (e.g., store) TTS engine 183, TTS AI voice model(s) 184 and initial audio content 186. TTS engine compute device 180 receives TTS AI voice model 174 from TTS AI voice model training compute device 170 and stores it as TTS AI voice model(s) 184. TTS engine compute device 180 can receive over time multiple TTS AI voice models 174, storing them as TTS AI voice model(s) 184 any one of which can be selected at a given time to be can be integrated into TTS engine 183 for a particular use (e.g., for a particular genre, for a particular voice actor, etc.). The TTS engine 183 can then receive set of text 105 from AI voice/TTS editor & audio tool compute device 100 and convert the text from set of text 105 into audio content, which can be stored as initial audio content 186. TTS engine compute device 180 can then send initial audio content 186 to AI voice/TTS editor & audio tool compute device 100 to be saved as initial audio content 106.

In one embodiment, all or a subset of the functions shown below as stored in memory 102 of AI Voice/TTS editor & audio generation tool compute device 100 including set of text 105, initial audio content 106, initial edits 107, audio to be edited 108, subset of text 109, preprocessing AI model 112, recording identification AI model 113, notification and alerting engine 114 and project management engine 115 can be contained in, and controlled by, AI Voice/TTS editor & audio generation tool 104. In some implementations, one or more of the functions performed by set of text 105, initial audio content 106, initial edits 107, audio to be edited 108 and subset of text 109 can be performed with more manual intervention and without the use of the AI Voice/TTS editor & audio generation tool 104.

The memory 102 of the AI voice/TTS editor & audio generation tool compute device 100 can include (e.g., store) a set of text 105. The set of text 105 can be any type of text, such as a word, a sentence, a paragraph, paragraphs, and/or the like. For example, the set of text 105 can include a book, an article, a script, and/or the like. The set of text 105 can be text for which an audio reading is desired (e.g., audiobook). In some implementations, the set of text 105 is represented in a text file, such as an epub, .docx or .pdf file. The set of text can be of any text in any language. In some implementations, the set of text can be extracted from a document or image (e.g., via optical character recognition).

The memory 102 of the AI voice/TTS editor & audio generation tool compute device 100 can also include (e.g., store) initial audio content 106. The initial audio content 106 can be generated by causing a representation of the set of text 105 to be sent to TTS engine compute device 180 and input into the TTS engine 183 using TTS AI voice model(s) 184 to output the initial audio content 186, which is then in turn sent to AI voice/TTS editor & audio generation tool compute device 100 and stored as initial audio content 106. The initial audio content 106 can be an audio version the set of text 105. In some instances, the initial audio content 106 is in a voice substantially the same as the voice of user U2. The initial audio content 106 can be generated automatically and/or without any human interventions (e.g., user U2 does not need to read any portions of set of text 105 via TTS engine 183 using the set of text 105).

The initial audio content 106 can largely resemble speech reading the set of text 105, but may include portions of audio that are less than desirable, such as audio having unclear pronunciation or awkward emphasis. As such, the memory 102 of the AI voice/TTS editor & audio generation tool compute device 100 can also include (e.g., store) a representation of audio to be edited 108 and subset of text 109. The audio to be edited 108 can be all or a subset of audio from the initial audio content 106 identified for editing and/or recommended to edited. The memory 102 can also include (e.g., store) a subset of text 109 from the set of text 105. The subset of text 109 can represent portions of the set of text 105 associated with the audio to be edited 108. The subset of text 109 for example can be a word, phrase, sentence, paragraph, and/or the like. For example, where the audio to be edited 108 includes audio of a sentence that is unclear, the subset of text 109 can include text of the sentence.

In some instances, the audio to be edited 108 and the subset of text 109 are identified by a user U1 at editor personnel compute device 120. For example, a representation of the set of text 105 and/or the initial audio content 106 can be sent from AI voice/TTS editor & audio generation tool compute device 100 to the editor personnel compute device 120. This can be coordinated, for example, by project management engine 115 (discussed further below), which can determine that the set of text 105 has been received and is to be (needs to be) processed by an editor such as user U1 at editor personnel compute device 120. User U1 can access the AI Voice/TTS editor & audio generation tool compute device 100 and the associated AI Voice/TTS editor & audio generation tool 104 via user interface 123. From there, the editor personnel compute device 120 can output to user U1 the set of text 105 (e.g., via display) and/or the initial audio content 106 (e.g., via speaker), using, for example, editing tool running on or accessed by editor personnel compute device 120, and the user U1 can identify portions of audio from the initial audio content 106 that are to be and/or are recommend to be further edited (e.g., recorded by a human). For example, the user U1 can identify audio that is unclear, in the wrong tone, without the proper emphasis, and/or the like. In some instances, the user U1 can provide an indication (e.g., comment, voice memo, etc.) indicating why the audio to be edited 108 is to be and/or is recommended to be further edited. In some instances, user U1, via user interface 123 accessing AI voice/TTS editor & audio generation tool compute device 100 and the associated AI voice/TTS editor & audio generation tool 104, can emphasize the subset of text 109 to be recorded (needing recording) by a human (e.g., highlighted, via start and stop markers, etc.), while the text from the set of text 105 that occurs before and/or after the subset of text 109 is not. That way, if all or portions of the audio to be edited 108 is to be recorded by a human (e.g., voice actor), the human doing the recording can record with knowledge of the issue at hand. The editor personnel compute device 120 can identify the subset of text 109 that corresponds to the audio to be edited 108. Once the audio to be edited 108 and the subset of text 109 are identified by a user (e.g., user U1) of the editor personnel compute device 120, via user interface 123, audio to be edited 108 and the subset of text 109 can be sent to AI voice/TTS editor & audio generation tool compute device 100 for storage in memory 102.

Additionally or alternatively, in some other embodiments, the audio to be edited 108 is identified by an artificial intelligence (AI) model such as a recording identification AI model 113. For example, the recording identification AI model 113 can receive the initial audio content 106 and/or the set of text 105 as input, and automatically identify the audio to be edited 108 and the subset of text 109. In some instances, the recording identification AI model 113 is trained using audio (not shown here) from previously recorded high quality audio content (e.g. audiobooks) such that the recording identification AI model can then identify in the initial audio content 106 audio that is not of high quality yielding then audio to be edited 108.

In some instances, the audio to be edited 108 and the subset of text 109 are identified at the AI voice/TTS editor & audio generation tool compute device 100 instead of or in addition to editor personnel compute device 120. In some instances, user U1 can log, via user interface 123 accessing AI Voice/TTS editor & audio generation tool compute device 100 and project management engine 115, that his/her tasks have been completed and then other users (e.g., user U2, user U3 and others not shown) can be alerted via the notification and alerting engine 114 that user U2 has completed the requested (identified or required) tasks and other users can now perform their requested (identified or required) tasks.

Notification and altering engine 114, included (e.g., stored) in memory 102 of AI voice/TTS editor & audio generation tool compute device 100, can provide notifications and alerts to other compute devices, such as voice actor compute device 130, as coordinated by project management engine 115. For example, after an initial audio content 106 (based on a set of text 105) has been received from TTS engine compute device 180, the notification and altering engine 114 can be triggered by project management engine 115 to send a notification to editor personnel compute device 120 to indicate that action by the editor on editor personnel compute device 120 (e.g., user U1) is needed (requested). In other instances, after the audio to be edited 108 and the subset of text 109 have been received from the editor personnel compute device 120, project management engine 115 can cause notification and altering engine 114 to provide a notification/alert to the voice actor that was involved in the initial training of TTS AI voice model 174 (e.g., user U2), via voice actor compute device 130. In response, voice actor compute device 130 can use user interface 135 to provide a notification to the voice actor who can then respond to the notification (e.g., by selecting a link) to initiate a process for capturing a user recording 139 to replace audio to be edited 108. For example, in response to the user input to initiate the process for capture, the subset of text 109, audio to be edited 108, and/or set of text 105 can be sent from AI voice/TTS editor & audio generation tool compute device 100 to the voice actor compute device 130. Alternatively, the voice actor (user U2) can log on to (access) AI voice/TTS editor & audio generation tool compute device 100 and associated AI voice/TTS editor & audio generation tool via user interface 135 to access the subset of text 109, audio to be edited 108, and/or set of text 105. At this point, the voice actor (user U2) can review what retakes are requested/needed, listen to and see the text for the retakes and listen to the audio surrounding the text for retakes.

Thereafter, the voice actor compute device 130, via the user interface 135, can use the microphone 133 to capture audio content as user U2 narrates the subset of text 109 (e.g., displayed to the user U2 via a display device (not shown)) to produce and store the user recording 139. In some instances, the voice of user U2 is substantially the same voice as of the initial audio content 106. In some instances, text from the set of text 105 that occurs before and/or after the subset of text 109 can also be displayed via user interface 135 at the voice actor compute device 130. In some instances, the subset of text 109 is emphasized (e.g., highlighted, via start and stop markers, etc.), while the text from the set of text 105 that occurs before and/or after the subset of text 109 is not. Since the voice actor user U2 can listen to how the audio of the subset of text 109 currently sounds in text-to-speech and listen to how the audio before and after that section sounds, the user U2 can take that into account when recording to make sure the user recording 139 will seamlessly meld with the surrounding text-to-speech audio. This approach enables the user recoding 139 to be seamlessly combined with the surrounding audio via audio merging compute device 160. Once stored as user recording 139, then it can be sent to TTS compute device 100 for storing in memory 102 (not shown in FIG. 1). In some instances, the user recording 139 can also be sent to the TTS AI voice model training compute device 170 (stored as user recording for retraining 179) for retraining the TTS AI voice model 174. Retraining the TTS AI voice model 104 using the user recording 179 can help to improve accuracy of the TTS AI voice model 174.

User U2 can log, via user interface 135 accessing AI Voice/TTS editor & audio generation tool compute device 100 and Project Management Engine 115, that his/her tasks have been completed and then other users (e.g., user U1, user U3, and others not shown) can be alerted via the notification and alerting engine 114 that user U2 has completed the requested (identified or required) tasks and user recordings 139 are ready.

At any point, the initial audio content 106, 186, audio to be edited 108, user recording 139,179 and/or updated audio content 167 can be further edited. For example, the initial audio content 106, 186 audio to be edited 108, user recording 139, 179 and/or updated audio content 167 can be further edited by a user (e.g., user U1, user U2, and/or user U3) and/or software model (e.g., AI model, non-AI model) using speech synthetic markup language (SSML), tags, shortcuts, mechanisms, and/or the like. In some cases, the memory 102 of the AI voice/TTS editor & audio generation tool compute device 100 can also include (e.g., store) initial edits 107. These can be initial edits made to set of text 105 using a variety of techniques including, but not limited to, using speech synthetic markup language (SSML), tags, shortcuts, mechanisms, and/or the like to improve the quality of the audio. This may include, for example, adding extra periods to the text to create a long pause in a certain place, adding exclamation points to cause emphasis, etc. Once those edits are made in the text, the initial edits 107 can be sent to TTS engine compute device 180 to generate revised audio in the form of audio to be edited 108. These edits can be made, for example, by user U1 on editor personnel compute device 120 via user interface 123 accessing AI voice/TTS editor & audio generation tool compute device 100 and the associated AI voice/TTS editor & audio generation tool 104. In some implementations, initial edits 107 can be made to initial audio content 106 via an audio merging compute device 180 and an audio editing tool 163 as described in detail below. Once those edits are made, that process results in audio to be edited 108. In some instances, an AI model can take a first pass at editing the initial audio content 106, 186, audio to be edited 108, user recording 139, 179 and/or updated audio content 167, and a user can take a second pass thereafter. The preprocessing AI model 112 of the AI Voice/TTS editor & audio generation tool compute device 100 is an example of such an AI model. Preprocessing AI model 112 can be trained using text from previously edited content (e.g., audiobooks), which can include for example SSML tags and other markings used to produce desired TTS audio when a TTS engine is used. Once trained, preprocessing AI model 112 can be used to automatically apply edits to set of text 105 to improve the audio quality prior to other steps described herein are employed. In this way, preprocessing AI model 112 can automatically generate, whole or in part, initial edits 107.

In some instances, audio merging compute device 160 can be used to perform further editing after user recordings 139 has been produced by a voice actor (e.g., user U2 at voice actor compute device 130) and sent to audio merging compute device 160. After user recordings have been produced, they can be further edited at audio merging compute device 160 by, for example, a user U3. User U3 can access and use audio editing tool 163, via user interface 165, for perform editing on audio 166 (which corresponds to user recording 139 produced at voice actor compute device 130, sent to audio merging compute device 160 and stored as audio 166) and user recording 169 to produce updated audio content 167, which can be considered a final product of audio content. Alternatively and/or in addition, user U3 can be alerted via user interface 165 (e.g. on a computer, phone, etc.) that audio editing/merging tasks are needed (requested, desired) via the notification and alerting engine 114 and can log on to (access) AI voice/TTS editor & audio generation tool compute device 100 and associated AI voice/TTS editor & audio generation tool to review where retakes were performed and where new audio is to be inserted, and then perform those functions. User U3 can log via user interface 165 accessing AI Voice/TTS editor & audio generation tool compute device 100 and project management engine 115, that his/her tasks have been completed and then other users (e.g., user U1, user U2, and others not shown) can be alerted via the notification and alerting engine 114 that user U3 has completed the requested (identified or required) tasks.

Project management engine 115 included (e.g., stored) at memory 102 of AI voice/TTS editor & audio generation tool compute device 100 can enable many of the tasks performed by user U1, user U2 and user U3 and the functions on compute devices 180, 100, 170, 130, 160 and 120 to be coordinated, overseen and/or managed. It may be used to assign editing and/or recording tasks to different users, present the status of those tasks, select which TTS AI voice model 184 to use for a specific audio project (e.g. audiobook development project), which TTS engine 183 to use, etc. Project management engine 115 can be accessed, for example, via user interfaces 123, 135 and/or 165 as well as other user interfaces (not shown) in alternative implementations such as a user interface employed by a dedicated project manager.

Although the above description with respect to FIG. 1 mentioned six different compute devices, in some implementations, more or less compute devices can be used. For example, in some instances, a single compute device can be used perform the functionalities of the AI voice/TTS editor & audio generation tool compute device 100, editor personnel compute device 120, voice actor compute device 130, audio merging compute device 160, TTS AI voice model training compute device 170 and/or TTS engine compute device 180. As another example, a compute device can be used to perform the functionalities of the editor personnel compute device 120 and voice actor compute device 130, but not the AI voice/TTS editor & audio generation tool compute device 100, audio merging compute device 160, TTS AI voice model training compute device 170 or TS engine compute device 180. In yet another example, a compute device can be used to perform the functionalities of the editor personnel compute device 120, voice actor compute device 130 and audio merging compute device 160 but not the other functions. These are just examples given that there are many different permutations. In some instances, a first entity can own/control one or more of the compute devices, and a second entity different than the first entity can own/control other compute devices or a single entity could control all control devices. In yet other implementations, one or more compute devices can be implemented in a cloud environment (e.g., shared computer system resources with on-demand availability) and one or more compute devices can act as client devices accessing the various functions within the cloud environment. For example, any of TTS AI voice model training compute device 170, TTS engine compute device 180 and/or AI voice/TTS editor & audio generation tool compute device 100 can be implemented in a cloud environment, and any of editor personnel compute device 120, audio merging compute device 160 and/or voice actor compute device 130 can act as client devices that access the functionality in the cloud environment in a software as a service (SaaS) type arrangement.

In some instances, a compute device (e.g., AI voice/TTS editor & audio generation tool compute device 100) can use tags (e.g., SSML tags, bookmarks, color highlights) to mark portions of the initial audio content 106. In some instances, different tags are associated with different meanings that can be recognized by AI voice/TTS editor & audio generation tool compute device 100, editor personnel compute device 120, voice actor compute device 130, TTS AI voice model training compute device 170, TTS engine compute device 180, and/or the like. For example, a first type of tag can indicate a beginning point of audio content from the initial audio content 106 to be recorded and/or replaced, and a second type of tag can indicate an end point of audio content from the initial audio content 106 to be recorded and/or replaced. As another example, a first type of tag can indicate that voice actor recording for text associated with the first type of tag is mandatory, while a second type of tag can indicate that voice actor recording for text associated with the second type of tag is desirable but not mandatory.

In some instances and/or in some embodiments, the notification and alerting engine 114 and project management engine 115 are optional and may not be required. For example, when the functions to be performed by user U1, user U2 and/or user U3 are combined and performed by one or two people and/or the functions of compute devices 100, 120, 160 and 130 are combined and performed on a smaller number of compute devices. Similarly, in some instances, if the functions to be performed by user U1, user U2 and user U3 are executed in a more manual way with less automated coordination, the notification and alerting engine 114 and project management engine 115 can be optional.

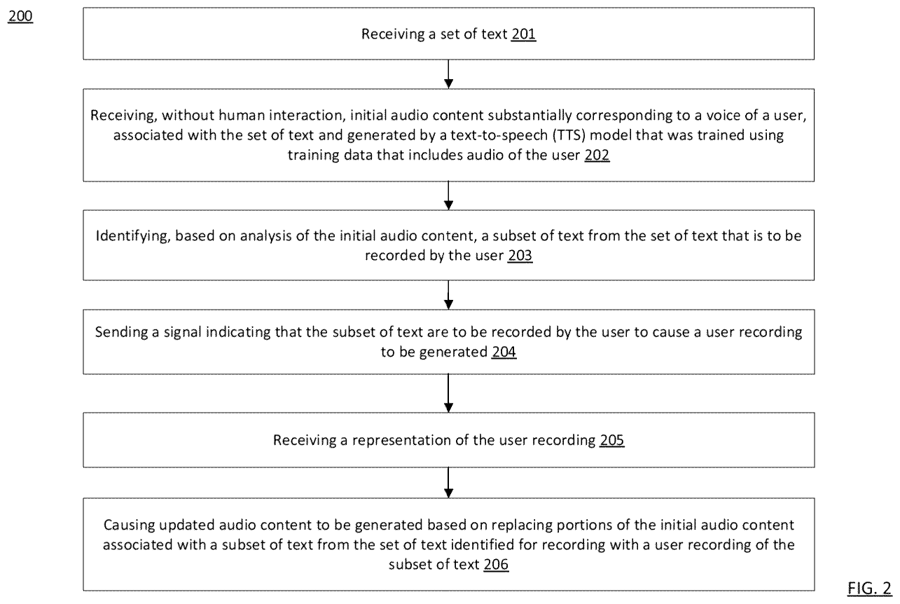

FIG. 2 shows a flowchart of a method 200 to cause updated audio content to be generated based on a set of text and a user recording of a subset of text, according to an embodiment. In some implementations, method 200 can be performed by a processor (e.g., processor 101, 121, 131, 161, 171 and/or 181). In one implementation, method 200 is performed by processor 101 at AI voice/TTS editor & audio generation tool compute device 100.

At 201, a set of text (e.g., set of text 105) is received. The set of text can be received from any compute device, such as a compute device associated with a user requesting narration of the set of text. For example, the set of text can be a book, an article, a script, and/or the like, for which an audio reading is desired (e.g., audiobook). The set of text can be received, for example, from a compute device (not shown in FIG. 1) associated with an audiobook producer.

At 202, initial audio content (e.g., initial audio content 106, 186) substantially corresponding to a voice of a user (e.g., a voice actor), associated with the set of text and generated by a TTS model (e. TTS AI voice model(s) 184) is received, with or without human interaction. In some implementations, 202 occurs automatically (e.g., without requiring human interaction) in response to completing 201. The initial audio content can be received, for example, from a compute device (e.g., TTS engine compute device 180 of FIG. 1) having a TTS AI voice model(s) (e.g., TTS AI voice model(s) 184 of FIG. 1).

At 203, a subset of text (e.g., subset of text 109) from the set of text that is to be recorded by the user (e.g., subset of text 109) is identified based on analysis of the initial audio content. The subset of text (e.g., subset of text 109) can be identified, for example, based on an analysis performed locally or remotely. For example, the subset of text can be identified based on an analysis performed locally by an AI model (e.g., recording identification AI model 113 of FIG. 1). Alternatively, the subset of text can be identified based on an analysis performed remotely by a human (e.g., user U1 of editor personnel compute device 120 via user interface 123 of FIG. 1). In such instance, the subset of text can be sent from the remote compute device and then identified at the subset of text locally (e.g., at AI voice/TTS editor & audio generation tool compute device 100 of FIG. 1).

At 204, a signal indicating that the subset of text are to be recorded by the user to cause a user recording to be generated is sent. For example, the signal can be sent to a compute device of a user (e.g., voice actor compute device 130 of user U2 of FIG. 1) where the user records the user recording (e.g., user recording 139 of FIG. 1). In an implementation, the voice of the user that generates the user recording is substantially the same as the voice output by the TTS model.

At 205, a representation of the user recording (e.g., user recording 139) is received. The representation of the user recorded (e.g., user recording 139) can be received from the compute device of the user (e.g., voice actor compute device 130 of user U2 of FIG. 1) where the user recorded the user recording.

At 206, updated audio content (e.g., updated audio content 167) is caused to be generated based on replacing portions of the initial audio content associated with the subset of text (e.g., subset of text 109) from the set of text identified for recording (e.g., audio to be edited 108) with the user recording (e.g., user recording 139) of the subset of text. More specifically, in some implementations, the aspects of 206 that relate to initiating the process for the voice actor to generate the voice content and to completing the process for processing the voice content after generated by the voice actor can occur automatically (e.g., without requiring human interaction) in response to completing 205. In some instances, the voice used to train TTS model is the same voice as the user that performed the recording. In some instances, the voice used to train TTS model is a different voice than the voice used for the user recording. In some instances, the voice used to train the TTS model and/or the TTS model is associated with a genre. For example, the TTS model may be trained using audio and/or text (e.g., multiple different books) from the same genre, where the audio used to train the TTS model may be using the same voice, which is also the same voice of the user that recorded the user record at 204.

In some implementations of method 200, causing the updated audio content to be generated at 206 includes causing, via the processor, the portions of the initial audio content to be updated (e.g., at TTS compute device 100, at voice actor compute device 130, at editor personnel compute device 120, at model compute device 150, at edit compute device 160, and/or a compute device not shown in FIG. 1) using the user recording to generate the updated audio content. In an implementation, the initial audio content and user recordings (e.g., user recordings 139) can be sent to (or accessed by) an audio merging compute device (e.g., audio merging compute device 160 of FIG. 1) to perform further editing such as replacing portions of the initial audio content associated with the subset of text (e.g., subset of text 109) with the user recording (e.g., user recording 139) of the subset of text, to produce updated audio content (e.g., updated audio content 167 of FIG. 1), which can be considered a final product of audio content.

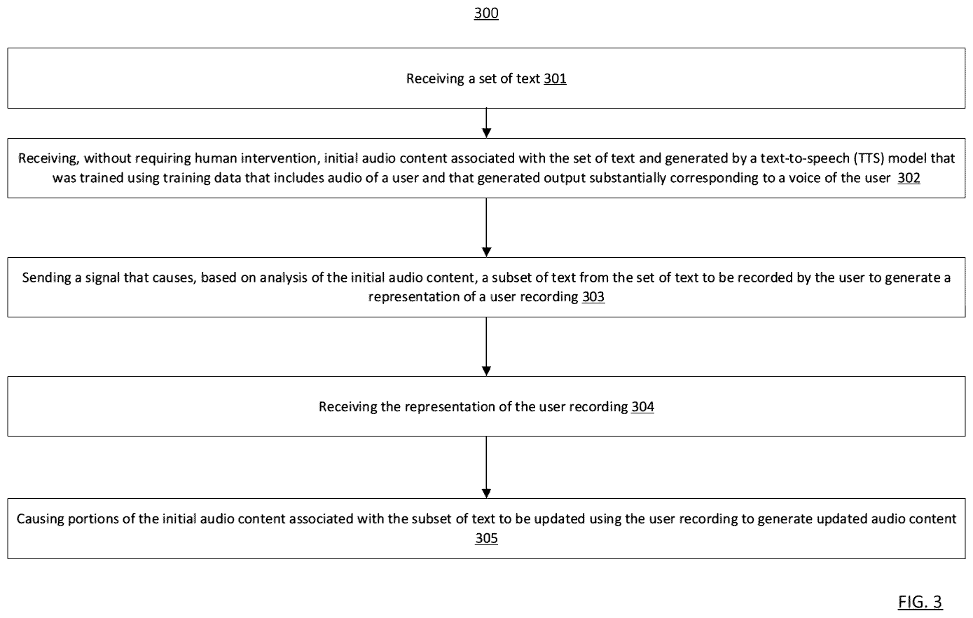

FIG. 3 shows a flowchart of a method 300 to cause updated audio content to be generated based on a set of text and a user recording of a subset of text, according to another embodiment. In some implementations, method 300 can be performed by a processor (e.g., processor 101, 121, 131, 161, 171 and/or 181).). In one implementation, method 300 is performed by processor 101 at AI voice/TTS editor & audio generation tool compute device 100.

At 301, a set of text (e.g., set of text 105) is received. For example, the set of text can be received via a processor (e.g., processor 101) of a first compute device (e.g., AI Voice/TTS editor & audio generation compute device 100). In some instances, the set of text is received from a remote compute device. For example, the set of text can be a book, an article, a script, and/or the like, for which an audio reading is desired (e.g., audiobook). The set of text can be received, for example, from a compute device (not shown in FIG. 1) associated with an audiobook producer.

At 302, initial audio content (e.g., initial audio content 186 or 106) associated with the set of text and generated by a TTS model (e.g., TTS AI voice model(s) 184) is received, with or without human interaction. In some implementations, 302 occurs automatically (e.g., without requiring human interaction) in response to completing 301. The initial audio content can be received, for example, from a compute device (e.g., TTS engine compute device 180 of FIG. 1) having a TTS AI voice model(s) (e.g., TTS AI voice model(s) 184 of FIG. 1).

At 303, a signal is sent, via the processor, to a second compute device (e.g., voice actor compute device 130) that is different from the first compute device. The signal causes, based on analysis of the initial audio content, a subset of text from the set of text to be recorded by the user to generate a user recording (e.g., user recording 139). For example, the signal can be sent to the second compute device, and the second compute device can generate an alert. Thereafter, the user (e.g., user U2) can use the second compute device to record the user recording. In some implementations, 303 occurs automatically (e.g., without requiring human interaction) in response to completing 302.

At 304, a representation of the user recording is received via the processor and from the second compute device. In some implementations, 304 occurs automatically (e.g., without requiring human interaction) in response to completing 303. In some implementations, 304 does not occur automatically in response to completing 303. The representation of the user recorded (e.g., user recording 139) can be received from the compute device of the user (e.g., voice actor compute device 130 of user U2 of FIG. 1) where the user recorded the user recording.

At 305, portions of the initial audio content associated with the subset of text (e.g., audio to be edited 108) are caused to be updated, via the processor and using the user recording, to generate updated audio content (e.g., updated audio content 167). In some implementations, 305 occurs automatically (e.g., without requiring human interaction) in response to completing 304. In an implementation, the initial audio content and user recordings (e.g., user recordings 139) can be sent to (or accessed by) an audio merging compute device (e.g., audio merging compute device 160 of FIG. 1) to perform further editing such as replacing portions of the initial audio content associated with the subset of text (e.g., subset of text 109) with the user recording (e.g., user recording 139) of the subset of text, to produce updated audio content (e.g., updated audio content 167 of FIG. 1), which can be considered a final product of audio content.

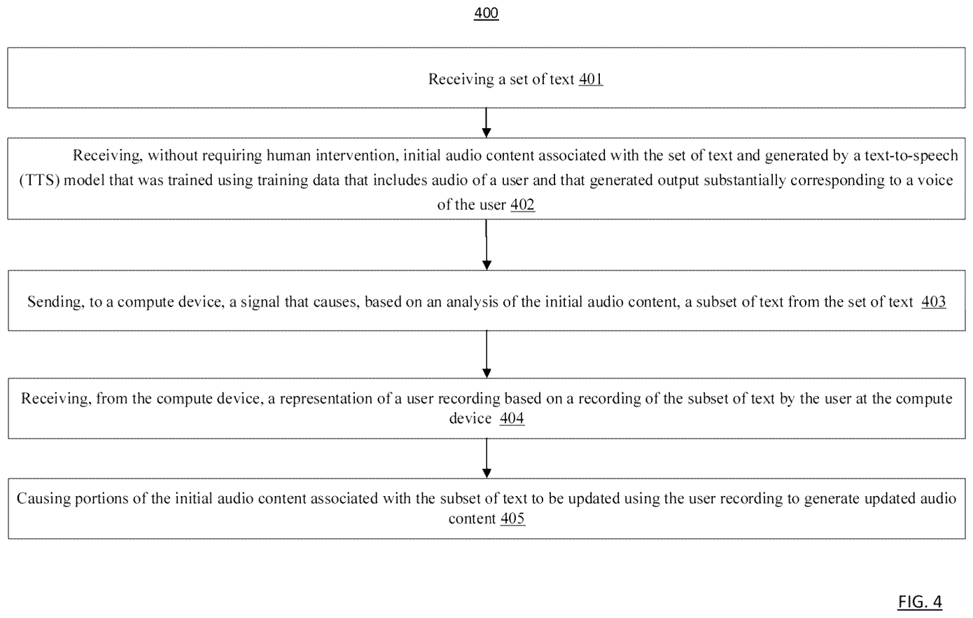

FIG. 4 shows a flowchart of a method 400 to cause updated audio content to be generated based on a set of text and a user recording of a subset of text, according to yet another embodiment. In some implementations, method 400 can be performed by a processor (e.g., processor 101, 121, 131, 161, 171 and/or 181).

At 401, a set of text (e.g., set of text 105) is received via a processor of a compute device. In some instances, the set of text is received from a remote compute device. In some instances, a user provides the set of text to the compute device (e.g., from memory, a flash drive, by typing, and/or the like). For example, the set of text can be a book, an article, a script, and/or the like, for which an audio reading is desired (e.g., audiobook). The set of text can be received, for example, from a compute device (not shown in FIG. 1) associated with an audiobook producer.

At 402, initial audio content associated with the set of text and generated by a TTS model (e.g., TTS AI voice model(s) 184) that was trained using training data that includes audio of a user and that generated output substantially corresponding to a voice of a user (e.g., user U2) is received. The initial audio content can be received, for example, from a compute device (e.g., TTS engine compute device 180 of FIG. 1) having a TTS AI voice model(s) (e.g., TTS AI voice model(s) 184 of FIG. 1). In some implementations, 402 occurs automatically (e.g., without requiring human interaction) in response to completing 401.

At 403, a signal is sent. The signal includes the subset of text from the set of text. The subset of text can be identified based on an analysis of the initial audio content. The signal causes, based on an analysis of the initial audio content, a subset of text (e.g., subset of text 109) from the set of text to be recorded by the user to generate a representation of a user recording. For example, the signal can be sent to the second compute device, and the second compute device can generate an alert. Thereafter, the user (e.g., user U2) can use the second compute device to record the user recording. In some implementations, 403 occurs automatically (e.g., without requiring human interaction) in response to completing 402.

At 404, a representation of the user recording (e.g., user recording 139) is received via the processor. The representation of the user recording (e.g., user recording 139) can be received, for example, from the second compute device where the user (e.g., user U2) generated an audio recording of the subset of text after being alerted to record the subset of text. In some implementations, 404 does not occur automatically in response to completing 403. The representation of the user recorded (e.g., user recording 139) can be received from the compute device of the user (e.g., voice actor compute device 130 of user U2 of FIG. 1) where the user recorded the user recording.

At 405, portions of the initial audio content associated with the subset of text (e.g., audio to be edited 108) are caused to be updated, via the processor and using the user recording, to generate updated audio content (e.g., updated audio content 167). In some implementations, 405 occurs automatically (e.g., without requiring human interaction) in response to completing 404. In an implementation, the initial audio content and user recordings (e.g., user recordings 139) can be sent to (or accessed by) an audio merging compute device (e.g., audio merging compute device 160 of FIG. 1) to perform further editing such as replacing portions of the initial audio content associated with the subset of text (e.g., subset of text 109) with the user recording (e.g., user recording 139) of the subset of text, to produce updated audio content (e.g., updated audio content 167 of FIG. 1), which can be considered a final product of audio content.

Although one or more embodiments discussed above relate to using audio from a voice actor to improve/correct and replace a portion(s) of audio produced by models discussed here (such as the TTS AI voice model), it should be understood that an inverse process is possible in combination with the one or more embodiments described herein. For example, a portion(s) of audio generated by a voice actor can be identified for improvement before it is used to replace portions of initial audio produced by a TTS AI voice model(s); in such an implementation, an AI-based model can be used to improve/correct the portion(s) of audio generated by the voice actor before that improved/corrected audio is used to replace portions of initial audio produced by a TTS AI voice model(s).

Combinations of the foregoing concepts and additional concepts discussed here (provided such concepts are not mutually inconsistent) are contemplated as being part of the subject matter disclosed herein. The terminology explicitly employed herein that also may appear in any disclosure incorporated by reference should be accorded a meaning most consistent with the particular concepts disclosed herein.

The skilled artisan will understand that the drawings primarily are for illustrative purposes, and are not intended to limit the scope of the subject matter described herein. The drawings are not necessarily to scale; in some instances, various aspects of the subject matter disclosed herein may be shown exaggerated or enlarged in the drawings to facilitate an understanding of different features. In the drawings, like reference characters generally refer to like features (e.g., functionally similar and/or structurally similar elements).

To address various issues and advance the art, the entirety of this application (including the Cover Page, Title, Headings, Background, Summary, Brief Description of the Drawings, Detailed Description, Embodiments, Abstract, Figures, Appendices, and otherwise) shows, by way of illustration, various embodiments in which the embodiments may be practiced. As such, all examples and/or embodiments are deemed to be non-limiting throughout this disclosure.

It is to be understood that the logical and/or topological structure of any combination of any program components (a component collection), other components and/or any present feature sets as described in the Figures and/or throughout are not limited to a fixed operating order and/or arrangement, but rather, any disclosed order is an example and all equivalents, regardless of order, are contemplated by the disclosure.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others. For example, although some of the embodiments discussed herein are described in the order of the generating TTS output and then replacing one or more portions with audio generated by a voice actor, it should be understood that the reverse order is possible: one or more portions audio can be first identified and generated by a voice actor (e.g., portions of audio that involve highly emotional content better read by a voice action rather than generated as TTS output), and then the TTS output can be generated and combined with the audio portions generated by the voice actor.

Embodiments, unless clearly indicated to the contrary, should be understood to mean “at least one.”

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules may include, for example, a processor, a field programmable gate array (FPGA), and/or an application specific integrated circuit (ASIC). Software modules (executed on hardware) can include instructions stored in a memory that is operably coupled to a processor, and can be expressed in a variety of software languages (e.g., computer code), including C, C++, Java™ Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

While specific embodiments of the present disclosure have been outlined above, many alternatives, modifications, and variations will be apparent to those skilled in the art. Accordingly, the embodiments set forth herein are intended to be illustrative, not limiting.

1. A method, comprising:
receiving, via a processor of a first compute device, a set of text;
receiving, via the processor and without requiring human intervention, initial audio content substantially corresponding to a voice of a user, associated with the set of text and generated by a text-to-speech (TTS) model that was trained using training data that includes audio of the user;
identifying, via the processor and based on analysis of the initial audio content, a subset of text from the set of text that is to be recorded by the user;
sending, via the processor and to a second compute device that is different from the first compute device, a signal indicating that the subset of text are to be recorded by the user to cause the second compute device to generate a user recording;
receiving, via the processor and from the second compute device, a representation of the user recording; and
causing, via the processor, portions of the initial audio content associated with the subset of text to be updated using the user recording to generate updated audio content.

2. The method of claim 1, wherein the receiving the initial audio content includes receiving the initial audio content from a third compute device that is different from the first compute device and the second compute device and that stores the TTS model.

3. The method of claim 1, wherein the identifying the subset of text includes:
sending, via the processor, the initial audio content to a third compute device different from the first compute device and the second compute device to cause the third compute device to generate an indication of the subset of text based on at least one of human input or a software model stored at the third compute device; and
receiving, via the processor and from the third compute device, the indication of the subset of text.

4. The method of claim 1, wherein:
sending, after the updating and to the second compute device, a signal having the updated audio content to cause the TTS model to be retrained based on the updated audio content.

5. The method of claim 1, wherein the set of text is a second set of text, the method further comprising:
receiving, at a preprocessing artificial intelligence (AI) model, a first set of text;
revising, at the preprocessing AI model, the first set of text to generate the second set of text to improve a quality of the initial audio content generated by the TTS model; and
outputting, from the preprocessing AI model, the second set of text.

6. The method of claim 1, further comprising:
receiving, at a recording identification AI model, a third audio content from the TTS model and/or the preprocessing AI model; and
outputting, from the recording identification AI model, an indication of a portion of the third audio content to be updated by the user.

7. An apparatus, comprising:
a processor; and
a memory coupled to the processor, the memory storing instructions that when executed cause the processor to:
receive a set of text;
receive, without requiring human intervention, initial audio content associated with the set of text and generated by a text-to-speech (TTS) model that was trained using training data that includes audio of a user and that generates output substantially corresponding to a voice of the user;
send, to a compute device, a signal that causes, based on analysis of the initial audio content, a subset of text from the set of text to be recorded by the user to generate a representation of a user recording;
receive the representation of the user recording; and
cause portions of the initial audio content associated with the subset of text to be updated using the user recording to generate updated audio content.

8. The apparatus of claim 7, wherein:
the compute device is a first compute device, the signal is a first signal,
the instructions to cause the processor to send include instructions to cause the processor to (1) send the signal to cause the first compute device to analyze the initial audio content and (2) send a second signal from the first compute device to a second compute device to cause the subset of text to be recorded by the user at the second compute device.

9. The apparatus of claim 7, wherein:
the compute device is a first compute device,
the instructions to cause the processor to cause portions of the initial audio content to be updated include instructions to cause the processor to send, to a second compute device, the portions of the initial audio content and the user recording to cause the second compute device to generate the updated audio content by the initial audio content with the user recording.

10. The apparatus of claim 7, wherein the instructions to cause the processor to cause portions of the initial audio content to be updated includes instructions to cause the processor to update, via the processor, the initial audio content with the user recording to generate the updated audio content.

11. The apparatus of claim 7, wherein:
the compute device is a first compute device,
the memory storing further instructions that when executed cause the processor to send, to a second compute device and after causing, a signal having the updated audio content to cause the TTS model to be retrained based on the updated audio content.

12. The apparatus of claim 7, wherein:
the set of text is a second set of text,
the memory storing further instructions that when executed cause the processor to:
receive, at a preprocessing artificial intelligence (AI) model, a first set of text;
revising, at the preprocessing AI model, the first set of text to generate the second set of text to improve a quality of the initial audio content generated by the TTS model; and
output, from the preprocessing AI model, the second set of text.

13. The apparatus of claim 7, wherein:
the memory storing further instructions that when executed cause the processor to:
receive, at a recording identification AI model, a third audio content from the TTS model and/or the preprocessing AI model; and
output, from the recording identification AI model, an indication of a portion of the third audio content to be updated by the user.

14. The apparatus of claim 7, wherein:
the TTS model is included within a plurality of TTS models, the user is included within a plurality of users,
each TTS model from the plurality of TTS models is trained with audio of a user from the plurality of users and not from remaining users from the plurality of users,
each TTS model from the plurality of TTS models is uniquely associated with a genre from a plurality of genres and is configured to generate output substantially corresponding to a voice from the plurality of users used to train that TTS model.

15. The apparatus of claim 7, wherein:
the TTS model is included within a plurality of TTS models, the user is included within a plurality of users,
each TTS model from the plurality of TTS models is trained with audio of a user from the plurality of users and not any other user, each TTS model from the plurality of TTS models is configured to generate output substantially corresponding to a voice from the plurality of users used to train that TTS model.

16. A processor-readable medium storing instructions that, when executed by a processor, cause the processor to:
receive a set of text;
receive, without requiring human intervention, initial audio content associated with the set of text and generated by a text-to-speech (TTS) model that was trained using training data that includes audio of a user and that generates output substantially corresponding to a voice of the user;
send, to a compute device, a signal that causes, based on analysis of the initial audio content, a subset of text from the set of text;
receive, from the compute device, a representation of a user recording based on a recording of the subset of text by the user at the compute device; and
cause portions of the initial audio content associated with the subset of text to be updated using the user recording to generate updated audio content.

17. The processor-readable medium of claim 16, wherein:
the compute device is a first compute device, the signal is a first signal,
the instructions to cause the processor to send include instructions to cause the processor to (1) send the signal to cause the first compute device to analyze the initial audio content and (2) send a second signal from the first compute device to a second compute device to cause the subset of text to be recorded by the user at the second compute device.

18. The processor-readable medium of claim 16, wherein:
the compute device is a first compute device,
the instructions to cause the processor to cause portions of the initial audio content to be updated include instructions to cause the processor to send, to a second compute device, the portions of the initial audio content and the user recording to cause the second compute device to generate the updated audio content by the initial audio content with the user recording.

19. The processor-readable medium of claim 16, wherein the instructions to cause the processor to cause portions of the initial audio content to be updated includes instructions to cause the processor to update, via the processor, the initial audio content with the user recording to generate the updated audio content.

20. The processor-readable medium of claim 16, wherein:
the compute device is a first compute device,
the instructions further includes instructions that when executed cause the processor to send, to a second compute device and after causing, a signal having the updated audio content to cause the TTS model to be retrained based on the updated audio content.

21. The processor-readable medium of claim 16, wherein:
the set of text is a second set of text,
the instructions further including instructions that when executed cause the processor to:
receive, at a preprocessing artificial intelligence (AI) model, a first set of text;
revise, at the preprocessing AI model, the first set of text to generate the second set of text to improve a quality of the initial audio content generated by the TTS model; and
output, from the preprocessing AI model, the second set of text.

22. The processor-readable medium of claim 16, wherein:
the instructions further including instructions that when executed cause the processor to:
receive, at a recording identification AI model, a third audio content from the TTS model and/or the preprocessing AI model; and
output, from the recording identification AI model, an indication of a portion of the third audio content to be updated by the user.

23. The apparatus of claim 16, wherein:
the TTS model is included within a plurality of TTS models, the user is included within a plurality of users,
each TTS model from the plurality of TTS models is trained with audio of a user from the plurality of users and not any other user, each TTS model from the plurality of TTS models is configured to generate output substantially corresponding to a voice from the plurality of users used to train that TTS model.
